(19) United States
(12) Patent Application Publication
(10) Pub. No.: US 2013/0122324 A1
(43) Pub. Date: May 16, 2013

(54) SURFACE TREATMENT METHOD FOR ALUMINUM OR ALUMINUM ALLOY AND ARTICLE MANUFACTURED BY THE SAME

(71) Applicant: DA-HUA CAO, Shenzhen City (CN)

(72) Inventor: DA-HUA CAO, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/526,764

(22) Filed: Jun. 19, 2012

(30) Foreign Application Priority Data
Nov. 14, 2011 (CN) 201110359169.2

(51) Int. Cl. B05D 7/14; B32B 15/01; B05D 3/10; B05D 1/36; B05D 1/18

(52) U.S. Cl. 428/637; 427/405; 427/328; 427/309; 428/652

(57) ABSTRACT

A surface treatment method for aluminum or aluminum alloy includes the following steps: An aluminum or aluminum alloy substrate is provided. A metallic nickel layer is formed on the aluminum or aluminum alloy substrate by replacement reaction using a water solution. The water solution substantially comprises nickel sulfate, sodium citrate, potassium sodium tartrate, and sodium hydroxide. An electroless nickel layer is then formed on the metallic nickel layer by electroless nickel plating. An article manufactured by the method is also provided.

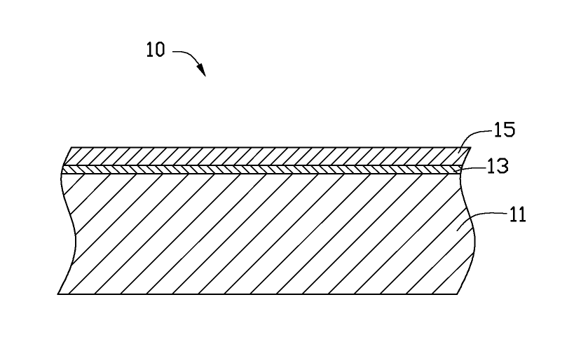

### BACKGROUND

1. Technical Field

The present disclosure relates to a surface treatment method for aluminum or aluminum alloy and articles manufactured by the method.

2. Description of Related Art

Aluminum or aluminum alloy substrate are usually double zincated before the electroless nickel plating in order to improve the bond between aluminum or aluminum alloy substrate and electroless nickel plating layer. However, during the electroless nickel plating, the zinc layer formed by the double zincating is prone to dissolving and produce zinc ion, which accelerates decomposition of the electroless solution and reduces the lifetime of the electroless solution used in the electroless nickel plating. Furthermore, when being corroded, the zinc layer of the double zincate treatment formed on the aluminum or aluminum alloy substrate will accelerate peeling of the electroless nickel plating layer from the substrate.

Therefore, there is room for improvement within the art.

### BRIEF DESCRIPTION OF THE DRAWING

Many aspects of the embodiment can be better understood with reference to the following drawings. The components in the drawings are not necessarily drawn to scale, the emphasis instead being placed upon clearly illustrating the principles of the exemplary disclosure. Moreover, in the drawings like reference numerals designate corresponding parts throughout the several views.

The FIGURE is a cross-sectional view of an exemplary embodiment of an article.

### DETAILED DESCRIPTION

Referring to the FIGURE, an exemplary surface treatment method for aluminum or aluminum alloy may include the following steps.

A substrate 11 is provided. The substrate 11 is made of aluminum or aluminum alloy.

The substrate 11 is degreased using a deoiling agent. The degreasing process may be carried out by immersing the substrate 11 in the deoiling agent for 2 minutes (min) to 5 min, the deoiling agent at a temperature of about 70° C. to about 75° C. The deoiling agent contains 25 g/L-35 g/L sodium phosphate (Na₃PO₄), 20 g/L-30 g/L sodium carbonate (Na₂CO₃), and 6 g/L-10 g/L sodium silicate (Na₂SiO₃).

The substrate 11 is activated to remove any oxide film formed on the substrate 11. The activating process comprises the steps of first activating the substrate 11, acid etching the substrate 11, and second activating the substrate 11. The oxide film may be formed when the substrate 11 is exposed to air.

The first activating process may be carried out by immersing the substrate 11 in a hydrochloric acid water solution for about 6 seconds to about 30 seconds. In the hydrochloric acid water solution, the volume ratio of the hydrochloric acid to water is about 2:1 to about 1:1.

The acid etching process may be carried out by immersing the substrate 11 in a nitric acid water solution for about 3 seconds to about 5 seconds, the nitric acid water solution at room temperature. In the nitric acid water solution, the volume ratio of the nitric acid to water is about 1:5 to about 1:3.

The second activating process may be carried out by immersing the substrate 11 in a sulfuric acid water solution for about 50 seconds to about 1 min, the sulfuric acid water at room temperature. The mass percentage of the sulfuric acid in the water solution is about 10% to about 20%.

A metallic nickel layer 13 is formed on the substrate 11 by replacement reaction. A water solution used in the replacement reaction contains nickel sulfate (NiSO₄), sodium citrate (C₆H₅Na₃O₇), potassium sodium tartrate (NaKC₄H₄O₆), and sodium hydroxide (NaOH). The molar concentration of the nickel sulfate is about 0.020 mol/L to about 0.038 mol/L. The molar concentration of the sodium citrate is about 0.20 mol/L to about 0.38 mol/L. The molar concentration of potassium sodium tartrate is about 0.02 mol/L to about 0.038 mol/L. The pH value of the water solution is about 10-11. The substrate 11 is immersed in the water solution at room temperature for about 2 min to about 5 min, and 3 min in the embodiment. The sodium citrate and the potassium sodium tartrate are complexing agents which react with the nickel ion in the water solution to form nickel complex compounds.

During the process of forming the metallic nickel layer 13, the sodium hydroxide cooperates with the sodium citrate and the potassium sodium tartrate to dissolve the residual oxide film on the surface of the substrate 11 first. Then, the aluminium on the surface of the substrate 11 reacts with the nickel ions to form the metallic nickel layer 13 on the substrate 11.

In the embodiment, the pH value of the water solution is 10-11. If the pH value of the water solution is lower than 10, the nickel complex compounds have poor stability, causing a poor bond between the metallic nickel layer 13 and the substrate 11. If the pH value of the water solution is higher than 11, nickel hydroxide precipitate is prone to forming in the water solution, which negatively affecting the formation of the metallic nickel layer 13 on the substrate 11.

In the embodiment, sodium citrate and potassium sodium tartrate are complexing agents, and the total molar concentration of the sodium citrate and the potassium sodium tartrate is 11-12 times to the molar concentration of the nickel ions. When only the sodium citrate is used, the deposition rate of the metallic nickel layer 13 would be too rapid to cause a loose metallic nickel layer 13. Decreasing the molar concentration of the sodium citrate can reduce the deposition rate of the metallic nickel layer 13, but also causes part of the nickel ion to form nickel hydroxide precipitate, which negatively affect the forming of the metallic nickel layer 13 on the substrate 11. When only potassium sodium tartrate is used, the deposition rate of the metallic nickel layer 13 is too slow and forming a high density metallic nickel layer 13.

An electroless nickel plating layer 15 is formed on the metallic nickel layer 13 by electroless nickel plating. The substrate 11 is immersed in an electroless water solution for about 30 min to about 1 h, the electroless water solution at a temperature of about 81° C. to about 85° C. The electroless water solution contains about 20 g/L—about 25 g/L nickel sulfate, about 25 g/L—about 30 g/L sodium metaphosphate (NaPO₃), about 25 g/L—about 35 g/L lactic acid, and about 15 g/L—about 20 g/L citric acid. The pH value of the electroless water solution is 4.5-5.5.

An article 10 manufactured by the exemplary method is also provided. The article 10 includes a substrate 11, a metallic nickel layer 13 formed on the substrate 11, and an electroless nickel plating layer 15 formed on the metallic nickel layer 13.

The substrate 11 is made of aluminum or aluminum alloy.

The article 10 can be a housing of a mobile-phone, a personal digital apparatus (PDA), a notebook computer, a portable music player, a GPS navigator, or a digital camera.

The exemplary embodiment forms the metallic nickel layer 13 on the substrate 11 instead of the traditional zincated layer, thus prolonging the lifetime of the electroless nickel plating solution. Additionally, the metallic nickel layer 13 has a high density and can be securely bonded to the substrate 11, thus enhancing the bond between the electroless nickel plating layer 15, the metallic nickel layer 13, and the substrate 11. As such, the corrosion resistance and wear resistance of the article 10 are improved.

### Example 1

Degreasing: the substrate 11 was immersed in a deoiling agent containing 25 g/L Na₃PO₄, 25 g/L Na₂CO₃, and 8 g/L Na₂SiO₃, the deoiling agent at a temperature of about 70° C. for about 5 min.

Firstly activating the substrate 11: the substrate 11 was immersed in a hydrochloric acid water solution for about 15 seconds. In the hydrochloric acid water solution, the volume ratio of the hydrochloric acid to water was about 1:4.

Acid etching the substrate 11: the substrate 11 was immersed in a nitric acid water solution for about 3 seconds, the nitric acid water solution at room temperature. In the nitric acid water solution, the volume ratio of the nitric acid to water was about 1:3.

Second activating the substrate 11: the substrate 11 was immersed in a sulfuric acid water solution for about 1 min, the sulfuric acid water solution at room temperature. The mass percentage of the sulfuric acid was about 10%.

Forming the metallic nickel layer 13: the substrate 11 was immersed in a water solution for about 3 min, the water solution at room temperature. The water solution contained nickel sulfate, sodium citrate, potassium sodium tartrate, and sodium hydroxide, wherein the molar concentration of the nickel sulfate was 0.003 mol/L, the molar concentration of the sodium citrate was 0.25 mol/L, the molar concentration of the potassium sodium tartrate was 0.025 mol/L. The pH value of the water solution was about 11.

Depositing the electroless nickel plating layer 15: the substrate 11 was immersed in an electroless solution for about 40 min, the electroless solution at a temperature of about 85° C. The electroless solution contains 20 g/L nickel sulfate, 25 g/L NaPO₃, 30 g/L lactic acid, and 15 g/L citric acid. The pH value of the electroless solution was 5.

### Comparison Example

Unlike example 1, the comparison example formed a double zincated layer on the substrate 11 instead of the metallic nickel layer 13. Except the above difference, the remaining experiment conditions of the comparison example were respectively the same as in example 1. The double zincated layer is formed by the following steps:

First zincating: the substrate 11 was immersed in a first zinc galvanizing agent for about 20 seconds, the first zinc galvanizing agent at room temperature. The first zinc galvanizing agent contained 300 g/L sodium hydroxide, 90 g/L zinc oxide, 8 g/L sodium tartrate, and 2 g/L ferric chloride. The substrate 11 was then dipped in a nitric acid water solution for about 10 seconds, the nitric acid water solution at room temperature. The volume ratio of nitric acid to water was 1:1.

Second zincating: the substrate 11 was immersed in a second zinc galvanizing agent for about 20 seconds, the second zinc galvanizing agent at room temperature. The second zinc galvanizing agent contained 150 g/L sodium hydroxide, 30 g/L zinc oxide, and 10 g/L sodium tartrate.

### Results of Example 1 and the Comparison Example

A salt spray test was performed on the articles formed by the example 1 and the comparison example. The salt spray test used a sodium chloride (NaCl) solution having a mass concentration of 5% at a temperature of 35° C. The test indicated that the corrosion resistance property of the article of example 1 lasted longer than 12 days, and the article of the comparison example lasted 8 days. Thus, the article of example 1 had a good corrosion resistance property.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A surface treatment method for aluminum or aluminum alloy, comprising:
providing an aluminum or aluminum alloy substrate;
forming a metallic nickel layer on the aluminum or aluminum alloy substrate by replacement reaction using a water solution, the water solution substantially comprising nickel sulfate, sodium citrate, potassium sodium tartrate, and sodium hydroxide; and
forming an electroless nickel layer on the metallic nickel layer by electroless nickel plating.

2. The surface treatment method of claim 1, wherein pH value of the water solution is about 10-11.

3. The surface treatment method of claim 2, wherein during forming of the metallic nickel layer, the substrate is immersed in the water solution for about 2 min to about 5 min, the water solution at room temperature.

4. The surface treatment method of claim 3, wherein in the water solution, molar concentration of nickel sulfate is about 0.020 mol/L to about 0.038 mol/L, molar concentration of sodium citrate is about 0.020 mol/L to about 0.038 mol/L, molar concentration of potassium sodium tartrate is about 0.020 mol/L to about 0.038 mol/L.

5. The surface treatment method of claim 3, wherein total molar concentration of the sodium citrate and the potassium sodium tartrate is 11-12 times to the molar concentration of nickel ion.

6. The surface treatment method of claim 1, wherein during forming the electroless nickel layer, the substrate is immersed in an electroless water solution for about 30 min to about 1 h, the electroless water solution at temperature of about 81° C. to about 85° C.

7. The surface treatment method of claim 6, wherein the electroless solution contains 20 g/L-25 g/L nickel sulfate, 25 g/L-30 g/L sodium metaphosphate, 25 g/L-35 g/L lactic acid, and 15 g/L-20 g/L citric acid.

8. The surface treatment method of claim 1, wherein the method further comprises a step of degreasing the substrate using a deoiling agent before forming the metallic nickel on the substrate.

9. The surface treatment method of claim 8, wherein the degreasing is carried out by immersing the substrate in a deoiling agent for 2 minutes to 5 minutes, the deoiling agent at a temperature from about 70° C. to about 75° C.

10. The surface treatment method of claim 9, wherein the deoiling agent contains 25 g/L-35 g/L sodium phosphate, 20 g/L-30 g/L sodium carbonate, and 6 g/L-10 g/L sodium silicate.

11. The surface treatment method of claim 1, wherein the method further comprises steps of activating the substrate before forming the metallic nickel on the substrate, the activating process comprise the steps of first activating the substrate, acid etching the substrate, and second activating the substrate.

12. The surface treatment method of claim 11, wherein during the first activating process, the substrate is immersed in a hydrochloric acid water solution for about 6 seconds to about 50 seconds.

13. The surface treatment method of claim 12, wherein in the hydrochloric acid water solution, the volume ratio of the hydrochloric acid to water is about 2:1 to about 1:1.

14. The surface treatment method of claim 11, wherein during the acid etching process, the substrate is immersed the substrate in a nitric acid water solution for about 3 seconds to about 5 seconds; in the nitric acid water solution, the nitric acid water solution at room temperature, the volume ratio of the nitric acid to water is about 1:5 to about 1:3.

15. The surface treatment method of claim 11, wherein during the second activating process, the substrate is immersed in a sulfuric acid water solution for about 50 seconds to about 1 min, the sulfuric acid water solution at room temperature.

16. The surface treatment method of claim 15, wherein the mass percentage of the sulfuric acid in the sulfuric acid water solution is about 10% to about 20%.

17. An article, comprising:
a substrate, the substrate being made of aluminum or aluminum alloy;
a metallic nickel layer formed on the substrate; and
an electroless nickel plating layer formed on the metallic nickel layer.
